(19) United States
(12) Patent Application Publication
(10) Pub. No.: US 2010/0328411 A1
(43) Pub. Date: Dec. 30, 2010

(54) PRINTING ON VINYL PRINT MEDIA

(76) Inventors: Sivapackia Ganapathiappan, Los Altos, CA (US); Howard S. Tom, San Jose, CA (US); Hou T. Ng, Palo Alto, CA (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/495,521

(22) Filed: Jun. 30, 2009

(51) Int. Cl. B41J 2/01; B05D 5/00

(52) U.S. Cl. 347/102; 427/256

(57) ABSTRACT

A system and method of ink-jet printing on vinyl print media can comprise jetting an ink-jet ink onto a vinyl print medium to form a printed image, and applying from 50-100° C. of heat to the printed image. The ink-jet ink can include a colorant, an aqueous liquid vehicle, and core-shell polymer particles. Upon printing and heating, at least a portion of the aqueous liquid vehicle evaporates, the vinyl print medium plasticizes (but does not flow), and the ink-jet ink flows. The fused polymer particles form a film that encapsulates at least a portion of the colorant.

### BACKGROUND

Polymers are often used to improve the durability of prints using a variety of printing techniques. One example is the dry toner used in the commercial printers. These include polymers that are insoluble in water and typically do not include surface groups for stabilization for printability. Usage of such polymers is therefore difficult in water-based ink-jet inks. To overcome this problem, latex polymers are sometimes used since such polymers show low viscosity with higher amount of solid contents. However, the final print durability is typically not as good compared to electrophotography-based (i.e. laser-based) print. In some cases, chemical fixers are used to improve waterfastness. However, such a system often does not show the desired improvement in terms of rub resistance. Therefore, new polymeric materials, additives, or improved process conditions are needed to achieve similar performance in water-based ink-jet printing applications as in electrophotographic printing, particularly on nonporous media.

### BRIEF DESCRIPTION OF THE DRAWINGS

Additional features and advantages of the disclosure will be apparent from the detailed description which follows, taken in conjunction with the accompanying figure, which together illustrate, by way of example, features of the invention.

FIG. 1A shows the result of a rub test conducted on a print prepared with ink-jet ink including core-shell latex particles in accordance with one embodiment described herein; and

FIG. 1B shows the result of a rub test conducted on a print prepared with ink-jet ink including latex particle that is not core shell.

Reference will now be made to the exemplary embodiments illustrated, and specific language will be used herein to describe the same. It will nevertheless be understood that no limitation of the scope of the disclosure is thereby intended.

### DETAILED DESCRIPTION

Before the present invention is disclosed and described, it is to be understood that this disclosure is not limited to the particular process steps and materials disclosed herein because such process steps and materials may vary somewhat. It is also to be understood that the terminology used herein is used for the purpose of describing particular embodiments only. The terms are not intended to be limiting because the scope of the present disclosure is intended to be limited only by the appended claims and equivalents thereof.

It is to be noted that, as used in this specification and the appended claims, the singular forms “a,” “an,” and “the” include plural referents unless the context clearly dictates otherwise.

As used herein, “liquid vehicle,” “vehicle,” or “liquid medium” refers to the fluid in which the colorant of the present disclosure can be dispersed or dissolved to form an ink-jet ink. Liquid vehicles are well known in the art, and a wide variety of ink vehicles may be used in accordance with embodiments of the present disclosure. Such ink vehicles may include a mixture of a variety of different agents, including without limitation, surfactants, organic solvents and co-solvents, buffers, biocides, viscosity modifiers, sequestering agents, stabilizing agents, anti-kogation agents, and water. Though not part of the liquid vehicle per se, in addition to the colorants, the liquid vehicle can carry solid additives such as polymers, latexes, UV curable materials, plasticizers, salts, etc. Additionally, the term “aqueous liquid vehicle” or “aqueous vehicle” refers to a liquid vehicle including water as a solvent.

As used herein, “liquid vehicle component” refers to any solvent, co-solvent, and/or liquid present in a liquid vehicle.

As used herein, “colorant” can include dyes, pigments, and/or other particulates that may be suspended or dissolved in a liquid vehicle prepared in accordance with embodiments of the present disclosure. Dyes are typically water soluble, and therefore, can be desirable for use in some embodiments. However, pigments can also be used in other embodiments. Pigments that can be used include self-dispersed pigments and standard pigments that are dispersed by a separate dispersing agent, e.g., polymer dispersed. Self-dispersed pigments include those that have been chemically surface modified with a small molecule, a polymeric grouping, or a charge. This chemical modification aids the pigment in becoming and/or substantially remaining dispersed in a liquid vehicle. The pigment can also be dispersed by a separate additive, e.g. a polymer, an oligomer, or a surfactant, in the liquid vehicle and/or in the pigment that utilizes a physical coating to aid the pigment in becoming and/or substantially remaining dispersed in a liquid vehicle.

As used herein, “pigment” generally includes pigment colorants, magnetic particles, aluminas, silicas, and/or other ceramics, organo-metallics or other opaque particles, whether or not such particulates impart color. Thus, though the present description primarily exemplifies the use of pigment colorants, the term “pigment” can be used more generally to describe not only pigment colorants, but other pigments such as organometallics, ferrites, ceramics, etc. In one specific embodiment, however, the pigment is a pigment colorant.

As used herein, “dye” refers to the individual compound, complex, or molecule responsible for an ink's color, and is typically water soluble. This term also includes dyes that affect the overall color of an ink but are not themselves the predominant color. For example, a black ink may contain one or more black dye(s) but may also contain a yellow dye allowing for a more neutral black color.

As used herein, T_{g} is the glass transition temperature as calculated by the Fox equation: copolymer T_{g}=1/(Wa/(T_{g} A)+Wb(T_{g} B)+ . . . ) where Wa=weight fraction of monomer A in the copolymer and T_{g}A is the homopolymer T_{g} value of monomer A, Wb=weight fraction of monomer B and T_{g}B is the homopolymer T_{g} value of monomer B, etc.

As used herein, the terms “rubfastness” and “smear fastness” each refer to the resistance of a printed ink image to removal by rubbing with solid object. One type of rubfastness of interest in the ink-jet printing art is resistance to rubbing with the tip of a highlighter. Smear refers to transfer of printed ink from a printed area to a surrounding area due to rubbing. Another type of disruption due to rubbing can include actual removal of the printed ink from the media surface. This can result from insufficient adherence of the ink to the media surface or absorbance of the ink into the surface, as well as insufficient shear resistance within the printed ink.

As used herein, the term “waterfastness” refers to the resistance of a printed ink image to dilution or removal by exposure to water. Waterfastness can be measured by wetting printed ink with water or an aqueous solution and determining any change in optical density of the printed ink.

When evaluating “rubfastness” or “waterfastness” of an image printed in accordance with the system and/or method of the present disclosure, “increased” or “improved” rubfastness can be determined by comparing the printed image with a comparative printed image. The comparative printed image can be prepared identically to the printed image except that the polymer particles used to generate the comparative printed image are not core-shell in structure. In other words, the same monomer content can be used in the comparative ink, except that the monomers are added so that the polymer particle structure is similar throughout the polymer particle, i.e. not core-shell. No other changes to the printing and fusing conditions are carried out.

The term “non-porous” when referring media refers to print media which has a Bristow Test of less than 2 ml/m² at a contact time of less than 0.5 s. The Bristow Test is known in the art and is summarized below. A test specimen of defined dimensions is affixed to the smooth rim of a wheel free to rotate at a defined constant speed in contact with a stationary test fluid applicator pressing against the test specimen with a defined pressure. The test fluid applicator consists of a test solution storage compartment affixed above a 1 mm by 15 mm test fluid delivery slot, the slot being positioned so that the long dimension is perpendicular to the direction of rotation of the rim of the wheel, and parallel to the wheel axis. A defined quantity of test fluid is placed through the fluid reservoir, onto the fluid delivery slot. With the wheel with the test specimen affixed thereto rotating at constant speed, the test solution applicator is brought into contact with the rotating test specimen and held in place under defined pressure. The test fluid is transferred from the test solution applicator onto the test specimen in a band whose width (controlled by the applicator slot width) is approximately 15 mm, and whose length is function of the absorptive characteristics of the test fluid interaction with the test specimen under the defined test conditions. The amount of liquid absorbed per unit area of test specimen is calculated from the volume of test fluid originally placed in the applicator, and the average width and length of the band created on the test specimen by the transferred test fluid. The time available for the liquid absorption is calculated from the volume of test fluid originally placed in the applicator and applicator geometry. It is noted that the printed images prepared using the systems and methods of the present disclosure are effective for both porous vinyl media and non-porous vinyl media, though it has typically been more difficult to print aqueous inks with acceptable rubfastness on non-porous vinyl media. This is a problem that is solved in particular in accordance with embodiments of the present disclosure.

As used herein, the term “about” is used to provide flexibility to a numerical range endpoint by providing that a given value may be “a little above” or “a little below” the endpoint. The degree of flexibility of this term can be dictated by the particular variable and would be within the knowledge of those skilled in the art to determine based on experience and the associated description herein.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 wt % to about 5 wt %” should be interpreted to include not only the explicitly recited values of about 1 wt % to about 5 wt %, but also include individual values and sub-ranges within the indicated range. Thus, included in this numerical range are individual values such as 2, 3.5, and 4 and sub-ranges such as from 1-3, from 2-4, and from 3-5, etc. This same principle applies to ranges reciting only one numerical value. Furthermore, such an interpretation should apply regardless of the breadth of the range or the characteristics being described.

A system and method for ink-jet printing images onto vinyl print media is described herein, including non-porous vinyl print media in some embodiments. In one embodiment, an ink-jet ink printing system can comprise a vinyl print medium, at least one ink-jet ink comprising an aqueous liquid vehicle, a colorant, and polymer particles including a core and a shell, and a heating device. The core can comprise polymerized hydrophobic monomer without crosslinking, and the shell can at least partially or completely surround the core. The shell can comprise polymerized hydrophobic monomer and polymerized acidic monomer, and optionally, crosslinkers. The system can be configured such that upon applying from 50-100° C. of heat from the heating device to the ink-jet ink printed on the media substrate, i) at least a portion of the aqueous liquid vehicle evaporates, ii) the vinyl print medium plasticizes, and iii) the ink-jet ink flows. Thus, the system is configured to form fused polymer particles in the form of a film that encapsulates at least a portion of the colorant.

In another embodiment, the method can include printing an ink-jet ink onto vinyl print media to create a printed image, where the ink-jet ink comprises an aqueous liquid vehicle, a colorant dissolved or dispersed in the vehicle, and core-shell polymer particles dispersed in the vehicle. An additional step includes applying from 50° C. to 100° C. of heat to the printed image to cause i) at least a portion of the aqueous liquid vehicle to evaporate, ii) the vinyl print medium to plasticize, and iii) the ink-jet ink to flow. The fused polymer particles can form a film that encapsulates at least a portion of the colorant.

In these embodiments, the core can include from 90 wt % to 100 wt % polymerized hydrophobic monomer and 0 wt % to 10 wt % polymerized acidic monomer. Also, there also is typically no crosslinking in the core. The shell surrounding the core can include including from 5 wt % to about 15 wt % polymerized acidic monomer, from 80 wt % to 95 wt % polymerized hydrophobic monomer, and from 0 wt % to 5 wt % of polymerized crosslinker.

Also, in each of these embodiments, the core-shell polymer particles can be formulated to fuse upon reaching an appropriate temperature after being printed and thereby create a film that encapsulates the printed image. The film produced can be durable enough to protect the printed image from damage due to physical and chemical rubbing. The film can also provide added waterfastness to the image. The durability and waterfastness improvements resulting from the present embodiments can include greatly improved highlighter smearfastness, rub resistance, wet smudge resistance and optical density (after highlighting smear). Incorporation of core-shell type latex polymers to the ink-jettable ink dispersions can help to increase the tensile strength of the film formed on a media and hence the enhanced print durability.

The present system and method utilizes polymer particles that are configured to provide a durable print film on a vinyl medium, where the particles are also configured to be part of a stable ink-jettable ink composition. To provide these characteristics, particles having a core-shell arrangement are used. More specifically, the particle can have a core that comprises a polymer or copolymer having a glass transition temperature (T_{g}) such that, upon printing, the particles can readily be induced to coalesce to form a durable film. In addition, the shell can be configured so as to provide stability or dispersability in a liquid ink-jet ink vehicle, such as an aqueous vehicle, so that the ink remains jettable from conventional ink-jet architecture.

In a more specific embodiment, polymer particles in accordance with the embodiments herein can include a highly hydrophobic core. More particularly, the core can comprise a polymerized hydrophobic monomer or a copolymer with a significant fraction of hydrophobic monomers. Hydrophobic monomers provide durability to the resulting print film and therefore result in the printed ink having substantial rubfastness and waterfastness. Hydrophobic monomers that are suitable for use in the core or the shell include but are not limited to methyl acrylate, ethyl acrylate, propyl acrylate, butyl acrylate, hexyl acrylate, lauryl acrylate, octadecyl acrylate, methyl methacrylate, ethyl methacrylate, propyl methacrylate, butyl methacrylate, hexyl methacrylate, lauryl methacrylate, octadecyl methacrylate, 2-ethylhexyl acrylate, 2-ethylhexyl methacrylate, methylstyrene, vinylbenzyl chloride and styrene. The monomers used can be selected to provide desired results in view of printing conditions, the ink-jet system to be used, or the particular medium onto which printing is done. It has been found that core-shell particles in which the core comprises styrene combined with butyl acrylate or butadiene provide unexpectedly favorable results when printed on vinyl media. Accordingly a specific embodiment, the core comprises polymerized styrene and butyl acrylate. In another specific embodiment, the core comprises polymerized styrene and butadiene.

In another aspect, the substantially hydrophobic core polymer can comprise a mixture in which hydrophobic monomers are polymerized with other monomer types. For example, the core can comprise a mixture of hydrophobic monomers and hydrophilic monomers, where the fraction of hydrophobic monomers is high enough so that the resulting polymer is substantially hydrophobic. In a more particular embodiment, hydrophobic monomer is present in the core at from 90 wt % to 100 wt %. A small amount of copolymerized acidic monomer, e.g., from 0 wt % to 10 wt %, can optionally be included with the hydrophobic monomers to facilitate synthesis of the core polymer. Suitable acidic monomers include acrylic acid, methacrylic acid, itaconic acid, maleic acid, and vinyl benzoic acid.

The core can constitute from 5% to 90% of the volume of the core-shell particle, with the shell comprising the balance of the particle volume.

The polymer particles can also be configured to stably disperse in an aqueous ink-jet ink vehicle. Therefore, in accordance with this embodiment, the particle core can be encapsulated by a more hydrophilic shell. More particularly, the shell can comprise a polymerized hydrophilic monomer or a copolymer with a significant fraction of hydrophilic monomers. In particular the shell polymer can contain acidic monomers. In one embodiment, the shell polymer can contain the same set of monomers that are present in the core, but in a different ratio. For example an acidic monomer that may be present in a small amount in the core polymer can be also present in the shell in a larger amount so as to confer hydrophilicity to the shell. In a particular embodiment, acidic monomer can be present in the shell in amount from about 5 wt % to about 15 wt %.

Acidic monomers that can be included in the core or the shell include acrylic acid, methacrylic acid, itaconic acid, maleic acid, and vinyl benzoic acid. These monomers provide surface charge to the particles so as to stabilize them in water. The imparted charge can be further enhanced by raising the pH of the ink so that the carboxyl group is converted to the salt form.

In a particular embodiment, the shell can also include cross-linking to provide shear strength to the particles before and during jetting. Cross-linking monomers can be present in the polymer up to about 5 wt %. Suitable cross-linking monomers include polyfunctional monomers and oligomers that contain an organic functional group available for cross-linking after polymerization. Cross-linking monomers that can be used in the high T_{g} polymer include, without limitation, ethylene glycol dimethacrylate, diethylene glycol dimethacrylate, ethylene glycol diacrylate, diethylene glycol diacrylate, 1,6-hexanediol diacrylate, tetraethylene glycol diacrylate, tripropylene glycol diacrylate, ethoxylated bisphenol A diacrylate, pentaerythritol tri- and tetraacrylate, N,N′-methylenebisacrylamide, divinylbenzene, and combinations thereof, mixtures thereof, and derivatives thereof. Consequently, an embodiment of the shell can include a crosslinker at up to 5 wt %, acidic monomer at from about 5 wt % to about 15 wt %, and hydrophobic monomer at from 80 wt % to 95 wt %.

Particles having a core-shell structure in accordance with the present disclosure can be synthesized in a single step emulsion process by polymerizing first the hydrophobic monomers followed by hydrophobic-hydrophilic monomers. This approach reduces the total number of steps used to prepare the core-shell latex particles. Furthermore, this approach allows one to implement and control a gradient of physical properties in the particle. In this way, the particle characteristics can be adjusted to accommodate a wider set of print media.

The polymers can be prepared by conventional emulsion polymerization techniques such as batch, semi-batch, or mini-emulsion processes. The core of the polymer particles are produced first, using the desired hydrophobic monomers to provide durability. Then acid containing shell monomers are added for stability and printability. There can be an abrupt compositional change from the polymer in the core to the polymer in the shell. Alternatively, there can be a compositional gradient from the polymer in the core to the polymer in the shell. Such a gradient (continuous change to the shell components from the core phase materials) may be achieved by adjusting the feed of monomer mixture during the polymerization.

The polymer particles can be incorporated into an ink-jet ink. In a particular embodiment, the ink-jet ink can also comprise a liquid vehicle and colorant. The liquid vehicle can be chosen for suitability with a particular ink-jet printing system or for uses with a particular print medium. As discussed above, the particles described herein provide a particular benefit for formulating aqueous ink-jet inks that produce good results on non-porous print media such as vinyl. As such, in a particular embodiment, the ink-jet ink vehicle includes water. The concentration range of the polymer particles in the ink can be in the range of from about 0.1 wt % to about 50 wt %, or more particularly from about 1 wt % to about 15 wt %, or still more particularly from about 3 wt % to about 6 wt %.

The vehicle may be largely water-based, or additional co-solvents can be included. More particularly, the vehicle can include organic co-solvents known in the art to be suited for formulating aqueous ink-jet inks. Suitable water soluble organic co-solvents, but are not limited to, aliphatic alcohols, aromatic alcohols, diols, triols, glycol ethers, poly(glycol) ethers, lactams, formamides, acetamides, long chain alcohols, ethylene glycol, propylene glycol, diethylene glycols, triethylene glycols, glycerine, dipropylene glycols, glycol butyl ethers, polyethylene glycols, polypropylene glycols, amides, ethers, carboxylic acids, esters, organosulfides, organosulfoxides, sulfones, alcohol derivatives, carbitol, butyl carbitol, cellosolve, ether derivatives, amino alcohols, and ketones. In particular, the co-solvent included can have a vapor pressure such that it will evaporate under heating as least as quickly as the water in the vehicle. In a more particular embodiment, the co-solvent evaporates more quickly than the water upon application of heat.

The pigments suitable for use in the ink-jet ink are not particularly limited, and inorganic pigments or organic pigments may be used. Suitable inorganic pigments include, for example, titanium oxide, cobalt blue (CoO—Al₂O₃), chrome yellow (PbCrO₄), and iron oxide. Suitable organic pigments includes, for example, azo pigments, polycyclic pigments (e.g., phthalocyanine pigments, perylene pigments, perynone pigments, anthraquinone pigments, quinacridone pigments, dioxazine pigments, thioindigo pigments, isoindolinone pigments and quinophthalone pigments), dye chelates (e.g., basic dye type chelates and acidic dye type chelate), nitropigments, nitroso pigments, and the like.

In conjunction with these or other pigments, non-limiting examples of dispersants that can be used in the formulations of exemplary embodiments of the present disclosure include Solsperse 32000, Solsperse 39000, Solsperse 5000, Solsperse 22000, Disperbyk 163, Disperbyk 167, Disperbyk 168, Disperbyk 180, Disperbyk 190, Disperbyk 191, or the like.

The ink-jet ink compositions can optionally also include wetting agents. Non-limiting examples of such wetting agents can include siliconepolyether acrylate such as Tego Rad 2200 N, Tego Rad 2300, and Byk 358N. The inks can also include polyether modified poly-dimethyl-siloxane wetting agents such as Byk 333, Byk 307, and Silwet L-7604. If used, wetting agents can be present at from 0.01% to about 10% by weight of the ink-jet ink composition.

The ink jet ink can further include other additives as needed to provide storage stability and jettability, including biocides, humectants, buffers, viscosity modifiers, sequestering agents, and stabilizing agents.

This system and method can provide durable and waterfast printing on media on which it is typically difficult to achieve such results. In particular, the system and method can be used for printing on media that do not absorb liquid inks well. These include non-porous surfaces such as vinyl. Polymer particles in accordance with the embodiments described herein, when formulated in an ink-jet ink, have been found to provide unexpectedly good results on vinyl media. Therefore, in a particular embodiment, the system and method includes printing on vinyl media.

By selection of the monomer mixture in the polymer core, the core polymer can be constituted so as to have a T_{g} that facilitates film formation under particular print and heating conditions. Print films formed from high T_{g} polymers can provide enhanced durability to a printed image encapsulated therewith. Therefore, it can be desirable to utilize particles having a high T_{g} polymer core. Generally, a high T_{g} polymer can be any polymer having a T_{g} of at least 45° C. In one embodiment, the high T_{g} polymer can have a T_{g} from about 45° C. to about 125° C. or any sub-range therein. In another embodiment, the high T_{g} polymer can have a T_{g} from about 50° C. to about 80° C.

These polymers provide a durable protective film over or throughout the printed ink because of the higher glass transition temperature. However, when high T_{g} polymers are printed on a substrate, they often do not form effective films from the printing process per se, i.e. they remain in a more particulate shape without coalescing to form a film. Consequently, these types of polymers have not been used as much as polymers with lower glass transition temperatures.

The methods and systems set forth herein provide ink-jet ink printing with inks that can include high T_{g} polymer particles. In accordance with a general embodiment, formation of print films with these inks can be facilitated by heating of the printed ink and/or the print media to a degree sufficient to cause particle coalescence. The T_{g} can be selected so that slight or moderate heating can be employed to cause coalescence. More particularly, the core polymer can be formulated to have a T_{g} such that the degree of heating needed to cause coalescence does not unduly disrupt the color provided by the ink or damage the print medium. For example, the core polymer can have a T_{g} that is within 10° C. of the ambient temperature at which printing occurs. Heating sufficient to cause the printed image to flow can be employed to insure that the proper interaction of particles, colorant, and print surface occurs so as to promote formation of the print film. In a more particular embodiment, the printed ink can be heated to a temperature of about 50° C. to about 100° C.

One aspect of the present embodiment provides durable ink-jet ink printing on vinyl media. As discussed above, it can be difficult to obtain satisfactory ink-jet printing on such media, as they do not readily absorb the quantity of liquid ink vehicle usually present in such inks. The present system and method provides an encapsulated print image through coalescence of printed latexes, facilitated in part by removal of a portion of the liquid vehicle. Heating of the printed ink or print medium in accordance with the present embodiment can cause film formation by evaporating away at least a portion of the liquid vehicle, or at least a portion of one of the liquid components of the liquid vehicle. Without being bound to a particular theory, it is believed that the evaporation of the vehicle both promotes collapse of the hydrophilic shell of the particles and brings the remaining particle cores into a denser arrangement. Therefore, the heat applied in the system and method can be sufficient to evaporate at least a portion of the liquid vehicle from the printed ink.

Another factor that can contribute to printing on vinyl media relates to how the vinyl medium itself reacts to the application of heat. That is, application of sufficient heat can cause a vinyl print surface to plasticize and become tacky. This tackiness, in combination with the heat-induced flow of the printed ink and fusion of polymer cores, can facilitate formation of a conformal film on the surface. The film and colorant adheres to the tackified surface, further enhancing the durability of the printed image. Therefore, in a particular embodiment the heat applied is sufficient to cause the vinyl surface to plasticize (without melting or flowing), but at the same time, the heat is sufficient to cause the core/shell polymer in the printed ink to flow.

A heating device can be incorporated into a print system in order to heat the media at or near the time of printing. Alternatively, the heating device can be used to heat the ink during or after jetting onto the medium.

Also provided is an ink-jet ink printing system and method can comprise at least one ink-jet ink comprising core-shell polymer particles as described herein and a vinyl print medium. The vinyl print medium can be typically any predominantly vinyl material used for durable display of printed images. Examples of such media include, but are not limited to Avery 1005, Avery 3000, Avery 3100, Avery MPI 1005 EZ, Avery MPI 4002, Ultraflex Normandy Pro, Ultraflex JetFlex FL, Ultraflex Strip Mesh, Ultraflex BIOflex, Verseidag Front Lit Standard Easy P/N 7945, LG Bannux 1100, 3M ScotchCal, Mactac JT5829, MacTac JT5929p, Intelicoat SBL-7SIJ, Intelicoat GFBL5SIJ, 3M Controltac Plus IJ180C-10, 3M ScotchLight, Dykson Jet 220, C2S Sterling Ultra Gloss and the like.

In accordance with the system and method, an ink-jet ink comprising a colorant, an aqueous liquid vehicle, and core-shell polymer particles is formulated for printing on a vinyl print medium. The resulting printed image can then be heated with a heating device to a temperature that promotes ink film formation and plasticizing of the vinyl print medium, e.g. about 50° C. to about 100° C., but that is not high enough to cause the vinyl print medium to flow. As water or other solvent(s) evaporate from the printed ink, the particles coalesce to encapsulate the colorant in a clear film. During this process, outer shell of the particle is collapsed and the core polymer is exposed. The temperature at which coalescence occurs is typically determined by the T_{g} of the core polymer. In accordance with one embodiment, the system can include a heating device configured to heat the ink. In a more particular embodiment, the heat source can be configured to heat the ink after it is printed on the print medium. In still another embodiment, the heating device can be configured to heat the surface of the print medium itself. The heating device can heat the surface directly via radiative heat, or can utilize a conductive or transmittive approach such as heating a surface of the medium other than the surface to be printed but in thermal connection with the print surface.

Summarizing and reiterating to some extent, a system and method of ink-jet printing and associated system have are disclosed which provide a durable print film for increased waterfastness and rub resistance. The ink-jet ink used can include particles with a polymer core configured to create a print film upon being printed upon a print medium. The particles can further include an encapsulating shell configured to provide stable dispersability in an aqueous ink-jet vehicle. In particular, durable and waterfast printing on vinyl print media is provided through the use of ink-jet printing and application of heat sufficient to cause the vinyl print medium to plasticize and the ink-jet ink to flow on the printed vinyl print medium substrate.

### EXAMPLES

The following examples illustrate embodiments of the disclosure that are presently known. Thus, these examples should not be considered as limitations of the disclosure, but are merely in place to teach how to make compositions of the present disclosure. As such, a representative number of compositions and their method of manufacture are disclosed herein.

### Example 1

### Synthesis of Core-Shell Latex Polymer with Styrene-Butyl Acrylate Core

Two monomer emulsions are prepared. The first monomer emulsion (for the core polymer) is prepared by emulsifying styrene (196 g) and butyl acrylate (44 g) in water (81 ml) containing 30% Rhodafac RS 710 (19.97 g). The second monomer emulsion (for the shell polymer) is prepared by emulsifying styrene (128 g), butyl acrylate (24 g) and methacrylic acid (8 g) in water (55 ml) containing 30% Rhodafac RS 710 (13.31 g). Initiator solution is prepared by dissolving potassium persulfate (0.695 g) in water (80 ml).

Water (1240 ml) is heated to a temperature of 90° C. Potassium persulfate (0.4 g) is added to the hot water followed by simultaneous addition of the initiator solution and the first emulsion over a period of 24 minutes. Starting 28 minutes after the addition of the first emulsion and initiator solution, the second emulsion is added over a period of 15 min.

The reaction mixture is maintained at a temperature of about 90° C. for a period of about 2.5 hours and then cooled to ambient temperature. The pH of this latex is then adjusted to 8.5 with 50% potassium hydroxide solution. The product is filtered with 200 mesh filter to obtain core-shell latex particles in water with about 20.5% solid content.

### Example 2

### Synthesis of Core-Shell Latex Polymer Having Commercial Styrene-Butadiene Carboxylated Latex Core

The shell monomer emulsion was prepared by emulsifying styrene (256 g), butyl acrylate (57.6 g) and methacrylic acid (6.4 g) in water (100 ml) containing 30% Rhodafac RS 710 (26.67 g). Initiator solution was prepared by dissolving potassium persulfate (1.11 g) in water (128 ml).

Water (1080 ml) was stirred well in a 5 L flask, and 30% Rhodafac solution (6.66 g) was added to the water. Then 160 g of a commercially available styrene-butadiene latex (ROVENE 4151, Mallard Creek Polymers, Charlotte, N.C.; available as 50% solution) was added. The mixture was heated to 90° C. Then 25 ml of initiator solution was added to the hot core latex containing solution and then simultaneously the remaining initiator solution and the emulsion were added over a period of 28 min.

The reaction mixture was maintained at a temperature of about 90° C. for a period of about 2.5 hours and then cooled to ambient temperature. The pH of this latex was then adjusted to 8.5 with 50% potassium hydroxide solution. It was filtered with 200 mesh filter to obtain the latex in about 22 wt % solid content.

### Example 3

### Synthesis of Latex without Core-Shell Structure

The synthesis procedure of Example 1 was repeated using the similar monomer set without separating core and shell components. The same quantities of the reagents were used, including the surfactants and initiator. The latex resulted in 21% solid content. This was used as a control sample for comparison with the latex from Example 1.

### Example 4

### Preparation of Ink-Jet Ink with Core-Shell Latex Particles from Example 1

An ink-jet ink composition was prepared by dispersing 6 wt % solid of the composition of Example 1 in a liquid vehicle. This liquid vehicle included 20 wt % organic co-solvents (2-pyrrolidone and hexanediols), 0.5 wt % surfactant and 0.5 wt % biocide with the balance being water. About 3 wt % of pigment was added to the ink as a colorant.

### Example 5

### Preparation of Ink with Latex from Example 2

An ink-jet ink composition was prepared by dispersing 6 wt % solid of the composition of Example 2 in a liquid vehicle. This liquid vehicle included 20 wt % organic co-solvents (2-pyrrolidone and hexanediols), 0.5 wt % surfactant and 0.5 wt % biocide with the balance being water. About 3 wt % of pigment was added to the ink as a colorant.

### Example 6

### Preparation of Ink with Latex from Example 3

An ink-jet ink composition was prepared by dispersing 6 wt % solid of the composition of Example 3 in a liquid vehicle. This liquid vehicle included 20 wt % organic co-solvents (2-pyrrolidone and hexanediols), 0.5 wt % surfactant and 0.5 wt % biocide with the balance being water. About 3 wt % of pigment was added to the ink as a colorant.

### Example 7

### Testing Rubfastness of Printed Inks on Vinyl Media

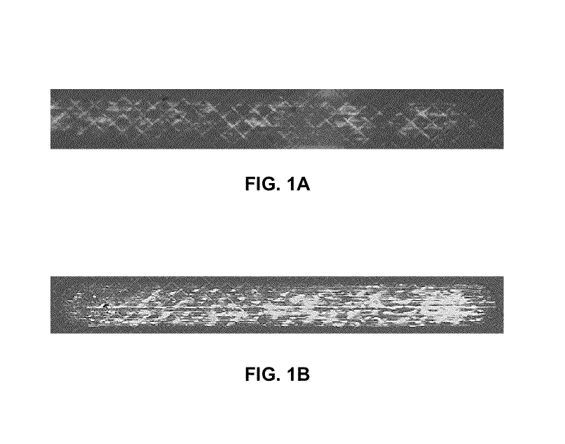

The inks from Example 4 and 6 were loaded into ink-jet pens and installed in a Hewlett-Packard ink-jet printer. The inks were printed on a pre-heated vinyl media to approximately 50° C. (i.e. above the T_{g} of the polymer core but below the T_{g} of the vinyl media), and the printings were subjected to a dry rub test. The dry rub test was performed with a linear abraser (TABER® Linear Abraser-Model 5750). The arm of the linear abraser stroked each media sample in a linear motion back and forth at a controlled stroke speed and length, the head of the linear abraser following the contours of the media samples. To the shaft of the arm of the linear abraser, a 250 gram weight was added to make the load constant. Specifically for the rub test, a stroking head or “wearaser” was attached to the end of the arm of the linear abraser. The stroking head was the size and shape of a pencil eraser and had a contact patch with a diameter of approximately ¼ inch diameter. The stroking head was abrasive (specifically CALIBRASE® CS-10) with a mild to medium abrasive effect. The stroking head was stroked back and forth 10 times on each media sample. The rubbed media samples, shown in FIGS. 1A-1B, were judged for image loss. The sample printed with the ink formulation of Example 4 (including the core-shell latex; FIG. 1A) exhibited markedly higher rubfastness than the sample printed with the ink of Example 6 (including the regular latex; FIG. 1B).

While the forgoing examples are illustrative of the principles of the present disclosure in one or more particular applications, it will be apparent to those of ordinary skill in the art that numerous modifications in form, usage and details of implementation can be made without the exercise of inventive faculty, and without departing from the principles and concepts of the disclosure. Accordingly, it is not intended that the invention be limited, except as by the claims set forth below.

What is claimed is:

1. An ink-jet ink printing system, comprising:
a) a vinyl print medium;
b) at least one ink-jet ink comprising an aqueous liquid vehicle, a colorant, and polymer particles including a core and a shell, said core comprising polymerized hydrophobic monomer and being devoid of polymerized crosslinker, and said shell at least partially surrounding the core and comprising polymerized hydrophobic monomer and polymerized acidic monomer; and
c) a heating device,
wherein the system is configured such that upon applying from 50-100° C. of heat from the heating device to the ink-jet ink printed on the media substrate:
i) at least a portion of the aqueous liquid vehicle evaporates,
ii) the vinyl print medium plasticizes, and
iii) the ink-jet ink flows,
and wherein upon cooling, fused polymer particles in the form of a film encapsulate at least a portion of the colorant on the vinyl print medium.

2. The system of claim 1, wherein the core includes from 90 wt % to 100 wt % polymerized hydrophobic monomer and 0 wt % to 10 wt % polymerized acidic monomer.

3. The system of claim 1, wherein the shell includes from 5 wt % to about 15 wt % polymerized acidic monomer, from 85 wt % to 95 wt % polymerized hydrophobic monomer, and from 0 wt % to 5 wt % polymerized crosslinker.

4. The system of claim 1, wherein the acidic monomer of the shell includes at least one of acrylic acid, methacrylic acid, itaconic acid, maleic acid, vinyl benzoic acid, or derivatives thereof.

5. The system of claim 1, wherein acidic monomer is also present in the core, and the acidic monomer of the core includes at least one of acrylic acid, methacrylic acid, itaconic acid, maleic acid, vinyl benzoic acid, or derivatives thereof.

6. The system of claim 1, wherein the hydrophobic monomer of the core or the shell independently includes at least one of methyl acrylate, ethyl acrylate, propyl acrylate, butyl acrylate, hexyl acrylate, lauryl acrylate, octadecyl acrylate, methyl methacrylate, ethyl methacrylate, propyl methacrylate, butyl methacrylate, hexyl methacrylate, lauryl methacrylate, octadecyl methacrylate, 2-ethylhexyl acrylate, 2-ethylhexyl methacrylate, methylstyrene, vinylbenzyl chloride, styrene, or derivatives thereof.

7. The system of claim 1, wherein the core comprises copolymerized styrene and butadiene.

8. The system of claim 1, wherein the core comprises copolymerized styrene and butyl acrylate.

9. The system of claim 1, wherein the shell comprises copolymerized styrene, butyl acrylate, and methacrylic acid.

10. The system of claim 1, wherein the core has a T_{g} of from about 45° C. to about 125° C.

11. The system of claim 1, wherein the core has a T_{g} of from about 50° C. to about 80° C.

12. The system of claim 1, wherein the core has a T_{g} within 10° C. of a temperature at which the jetting step is performed.

13. The system of claim 1, wherein the liquid vehicle further includes at least one organic co-solvent that evaporates more quickly than water upon application of heat from the heating device.

14. The system of claim 1, wherein the polymer particles are present in the ink-jet ink at from about 0.1 wt % to about 50 wt %.

15. The system of claim 1, wherein the polymer particles are present in the ink-jet ink at from about 1 wt % to about 15 wt %.

16. The system of claim 1, wherein the polymer particles are present in the ink-jet ink at from about 3 wt % to about 6 wt %.

17. The system of claim 1, wherein the vinyl print medium is non-porous.

18. The system of claim 1, wherein the printed image when generated using the system has increased rubfastness compared to a comparative printed image, said comparative printed image being prepared identically to the printed image except that the polymer particles used to generate the comparative printed image are not core-shell in structure.

19. A method of ink-jet printing on vinyl print media, comprising:
a) jetting an ink-jet ink onto a vinyl print medium to form a printed image, said ink-jet ink including a colorant, an aqueous liquid vehicle, and polymer particles, comprising:
i) a core including from 90 wt % to 100 wt % polymerized hydrophobic monomer and 0 wt % to 10 wt % polymerized acidic monomer, and wherein there is no crosslinking in the core, and
ii) a shell surrounding the core, said shell including from 5 wt % to about 15 wt % polymerized acidic monomer, from 80 wt % to 95 wt % polymerized hydrophobic monomer, and from 0 wt % to 5 wt % of polymerized crosslinker; and
b) applying from 50° C. to 100° C. of heat to the printed image to cause:
i) at least a portion of the aqueous liquid vehicle to evaporate,
ii) the vinyl print medium to plasticize, and
iii) the ink-jet ink to flow,
wherein fused polymer particles form a film that encapsulates at least a portion of the colorant.

20. The method of claim 19, wherein the acidic monomer in the core or shell is independently at least one of acrylic acid, methacrylic acid, itaconic acid, maleic acid, vinyl benzoic acid, or derivatives thereof; the hydrophobic monomer in the core or shell independently at least one of methyl acrylate, ethyl acrylate, propyl acrylate, butyl acrylate, hexyl acrylate, lauryl acrylate, octadecyl acrylate, methyl methacrylate, ethyl methacrylate, propyl methacrylate, butyl methacrylate, hexyl methacrylate, lauryl methacrylate, octadecyl methacrylate, 2-ethylhexyl acrylate, 2-ethylhexyl methacrylate, methylstyrene, vinylbenzyl chloride, styrene, or derivatives thereof; and wherein the core has a T_{g} of from about 45° C. to about 125° C.
